(19) United States
(12) Patent Application Publication
(10) Pub. No.: US 2026/0227088 A1
(43) Pub. Date: Aug. 6, 2026

(54) METHODS AND SYSTEMS FOR ACCESSING AND REPLACING FLOW SENSORS IN A BUILDING CONTROLLER

(71) Applicant: Honeywell International Inc., Charlotte, NC (US)

(72) Inventors: Bastian Gindroz, Neuchatel (CH); Haitao Li, Beijing (CN); Susana Natalie De Luis Mata, Azcapotzalco (MX); Jorge Braulio Martinez Steffani, Azcapotzalco (MX)

(21) Appl. No.: 19/042,163

(22) Filed: Jan. 31, 2025

(51) Int. Cl. F24F 11/88; G01F 15/18

(52) U.S. Cl. CPC F24F 11/88; G01F 15/18

(57) ABSTRACT

A building controller includes a flow sensor door that enables access to a removable flow sensor. The flow sensor connects to a printed circuit board through terminal pins and has tubing ports accessible from outside the controller housing. The door operates through a two-stage opening mechanism—first rotating about an axis guided by rotation guide members, then translating away from the rotation axis along guide members. The translation path can include stops to control door movement and prevent complete detachment. The door includes top and bottom nubs on its sides that engage with the guide members to facilitate the controlled opening motion. The door can include a detent mechanism to maintain closure until deliberately opened. The system enables removal and replacement of the flow sensor by disconnecting its terminal pins after opening the door through the rotation and translation motions.

### TECHNICAL FIELD

The present disclosure relates generally to building controllers, and more particularly to building controllers that include flow sensors that are field replaceable.

### BACKGROUND

Building controllers are used in controlling various systems such as HVAC (Heating, Ventilating and Air Conditioning) systems in a variety of different facilities. Many building controllers include flow sensors that may need to be field replaceable. A flow sensor may be electrically coupled to electronics within the building controller, and may be coupled to sample ports via pneumatic lines. The design of many building controllers does not make it easy to remove an existing flow sensor and install a new flow sensor in its place. In many building controllers, it may be necessary to terminate the power supply to the building controller as well as remove at least part of the outer casing of the building controller to expose the flow sensor. The process can be complicated and time consuming. What would be desirable are building controllers that are configured to permit a flow sensor to be easily removed and replaced in the field.

### SUMMARY

The present disclosure relates generally to building controllers, and more particularly to building controllers that include flow sensors that are field replaceable. An example may be found in a method for removing a flow sensor of a building controller. In this example, the building controller includes a building controller housing, a printed circuit board housed by the building controller housing, one or more wiring terminal blocks operatively coupled to the printed circuit board and accessible from outside of the building controller housing, and a flow sensor with one or more tubing ports that are accessible from outside of the building controller housing. The flow sensor includes terminal pins that are electrically connected to the printed circuit board via a flow sensor connector. The illustrative method includes opening a flow sensor door of the building controller housing by initially rotating the flow sensor door about a rotation axis guided by one or more rotation guide members, followed by translating at least part of the flow sensor door away from the rotation axis guided by one or more translation guide members. The terminal pins of the flow sensor are disconnected from the flow sensor connector, and the flow sensor is removed from the building controller. A replacement flow sensor can then be installed in a reverse manner.

Another example may be found in a building controller. The building controller includes a building controller housing including a flow sensor door, a printed circuit board housed by the building controller housing, one or more wiring terminal blocks operatively coupled to the printed circuit board and accessible from outside of the building controller housing, and a flow sensor with one or more tubing ports that are accessible from outside of the building controller housing. The flow sensor includes terminal pins that are electrically connected to the printed circuit board via a flow sensor connector. The flow sensor is operatively attached to the flow sensor door. The building controller housing is configured to allow the flow sensor door to move between a closed position and an open position. When moving from the closed position to the open position, the flow sensor door initially rotates about a rotation axis guided by one or more rotation guide members, followed by translating at least part of the flow sensor door away from the rotation axis guided by one or more translation guide members. The flow sensor may be removed and replaced with a replacement flow sensor.

Another example may be found in a method for removing a flow sensor of a building controller. The building controller includes a building controller housing that defines a flow sensor door opening to accommodate a flow sensor door. The flow sensor door opening includes a top, bottom and two lateral sides, and the building controller further includes a printed circuit board housed by the building controller housing, one or more wiring terminal blocks operatively coupled to the printed circuit board and accessible from outside of the building controller housing, and a flow sensor with one or more tubing ports that are accessible from outside of the building controller housing. The flow sensor includes terminal pins that are electrically connected to the printed circuit board via a flow sensor connector, the flow sensor operatively attached to the flow sensor door. The method includes opening the flow sensor door of the building controller housing, including rotating the flow sensor door about a rotation axis adjacent the bottom of the flow sensor door and translating the rotation axis of the flow sensor door away from the bottom of the flow sensor door opening of the building controller housing. The terminal pins of the flow sensor are disconnected from the flow sensor connector and the flow sensor is removed from the flow sensor door. A replacement flow sensor can then be installed in a reverse manner.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a perspective view of an illustrative building controller;

FIGS. 2, 3 and 4 are perspective views of a portion of the illustrative building controller of FIG. 1, showing a step-by-step process of easily accessing one or more flow sensors within the illustrative building controller;

FIG. 5 is a perspective view of an illustrative flow sensor assembly usable in the illustrative building controller of FIG. 1;

FIG. 6 is a perspective view of an illustrative flow sensor forming part of the illustrative flow sensor assembly of FIG. 5;

FIG. 7 is a lower perspective view of an illustrative backing plate forming part of the illustrative flow sensor assembly of FIG. 5;

FIG. 8 is a first perspective view of a first side of an illustrative door opening formed in a building controller housing forming part of the illustrative building controller of FIG. 1;

FIG. 9 is a second perspective view of a second side of the illustrative door opening of FIG. 8;

FIG. 10 is a first perspective view of a first side of an illustrative door that fits into the illustrative door opening shown in FIGS. 8 and 9;

FIG. 11 is a second perspective view of a second side of the illustrative door of FIG. 10;

FIG. 12 is a flow diagram showing an illustrative method for removing a floor sensor of a building controller; and

FIG. 13 is a flow diagram showing an illustrative method for removing a floor sensor of a building controller.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

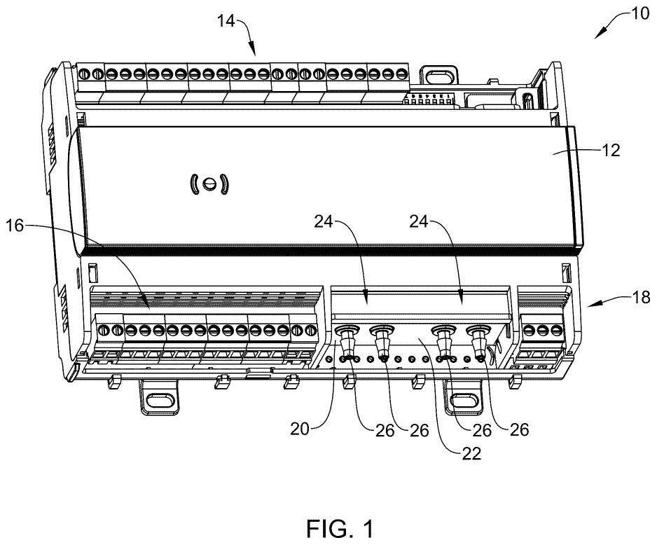

FIG. 1 is a perspective view of an illustrative building controller 10. The illustrative building controller 10 may be used to control part or all of any of a variety of different building systems. As an example, the building controller 10 may control operation of a component of an HVAC (Heating, Ventilating and Air Conditioning) system, such as a Variable Air Volume (VAV) box of an HVAC system. The building controller 10 includes a building controller housing 12. In some cases, the building controller housing 12 may be configured to be wall-mounted or mounted within an electrical panel. In some cases, the building controller housing 12 may be configured to be mounted to a DIN rail that is itself wall-mounted or mounted within an electrical panel. While not visible in this view, the building controller 10 includes one or more PCBs (Printed Circuit Board), at least one of which includes a controller that controls operation of the building controller 10 and thus controls operation of whatever component or components the building controller 10 is responsible for controlling.

The building controller 10 includes a number of wiring terminals, including a set of wiring terminals 14 on one side of the building controller housing 12, a set of wiring terminals 16 on an opposing side of the building controller housing 12, and a smaller set of wiring terminals 18 also on the opposing side of the building controller housing 12. Each wiring terminal of the sets of wiring terminals 14, 16, and 18 may be electrically coupled to the PCB(s) located within the building controller housing 12, and as seen extend to be accessible from outside of the building controller housing 12. Each wiring terminal of the sets of wiring terminals 14, 16, and 18 may be configured to allow individual wires to be mechanically and electrically connected to corresponding wiring terminals of the sets of wiring terminals 14, 16, and 18 in order to electrically couple the building controller 10 with each of a variety of remote components such as motors, pumps, sensors, VAV boxes, and the like. The building controller 10 may include any number of wiring terminals arranged in any desired configuration, and thus the sets of wiring terminals 14, 16, and 18 are merely illustrative.

The building controller 10 includes one or more flow sensors that are housed within the building controller housing 12. The individual flow sensors may be any suitable flow sensor or part of any suitable flow sensor. For example, one or more of the flow sensors may be or may include a thermal mass flow sensor, sometimes with a heating element. In another example, one or more of the flow sensors may be or may include a pressure sensor, and in some cases, an absolute pressure sensor and/or a differential pressure sensor. These are just examples. It is contemplated that the one or more flow sensors may include any sensor type that is suitable to help obtain a measure a flow of a gas or liquid via one or more ports.

The building controller housing 12 defines a door opening 20 that accommodates a flow sensor door 22. As shown, the flow sensor door 22 accommodates a pair of flow sensors 24, each of which include a pair of tubing ports 26. In some cases, each pair of flow sensors 24 may form an absolute pressure sensor and/or a differential pressure sensor from which a flow rate may be derived. In some cases, each of the flow sensors 24 may be a microbridge mass airflow sensor. In some cases, the building controller 10 may include a combination of the two or more sensor types. While the flow sensor door 22 is shown as accommodating a pair of flow sensors 24, in some cases, the flow sensor door 22 may be larger, and may be configured to accommodate three or more flow sensors 24. In some cases, the flow sensor door 22 may be smaller, and may be configured to only accommodate a single flow sensor 24. Moreover, the particular location of the door opening 20 and the flow sensor door 22 shown in FIG. 1 is merely illustrative, as a variety of different configurations are contemplated.

Each of the tubing ports 26 are configured to be connected to pneumatic tubing (not shown) that extends from the tubing ports 26 to sampling ports that are distributed about predetermined locations in the facility. As an example, a pair of sampling ports may be disposed in a heating duct, but spaced apart, so that the flow sensor 24 is able to determine a flow rate within the heating duct by detecting a pressure drop between an upstream sampling port and a downstream sampling port. In some cases, the tubing ports 26 may be configured to allow pneumatic tubing to be releasably secured to each tubing port 26, meaning that the pneumatic tubing remains secured to each tubing port 26 when desired, but is easily removed from each tubing port 26 when replacing one of the flow sensors 24. The building controller 10 may include features that facilitate removal and replacement of one or more of the flow sensors 24 easily, without requiring the use of tools or disassembling the building controller housing 12, and without requiring powering down the building controller 10 and whatever component(s) is(are) being controlled by the building controller 10.

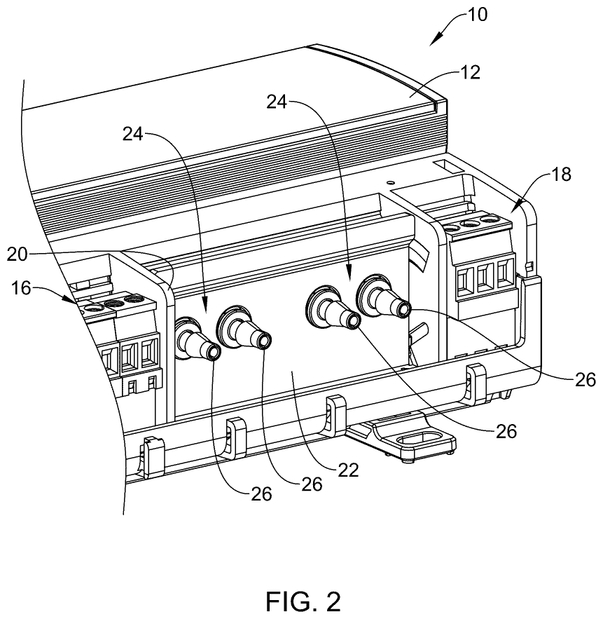

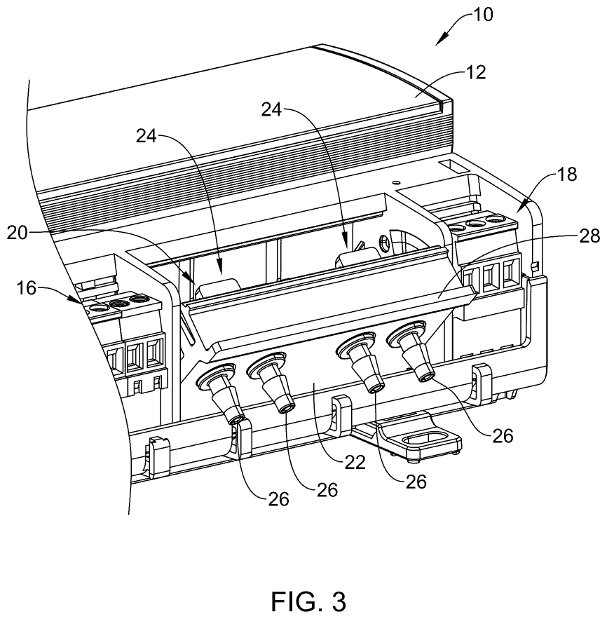

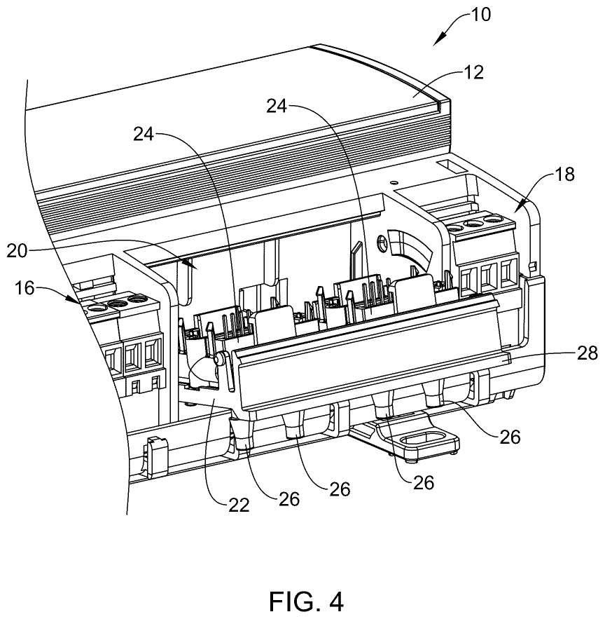

FIGS. 2, 3, and 4 are perspective views of a portion of the building controller 10, showing a step-by-step process of easily accessing one or more flow sensors 24 within the building controller 10. In FIG. 2, the flow sensor door 22 is shown closed relative to the door opening 20. This arrangement may correspond to normal operation of the building controller 10. In FIG. 3, the flow sensor door 22 has been initially rotated about a rotation axis, as will be discussed. In some cases, the flow sensor door 22 may be considered as including a handle 28 that may be used by a user to engage the flow sensor door 22 and to cause the flow sensor door 22 to rotate (as shown in FIG. 3). After passing through a rotation range around the rotation axis as seen in FIG. 4, the flow sensor door 22 may be translated and in some cases rotated further. As can be seen in FIG. 4, the flow sensors 24, which are disposed behind the flow sensor door 22, and which in some cases may be releasably secured to a back side of the flow sensor door 22, have been exposed and can be easily removed and replaced by the user.

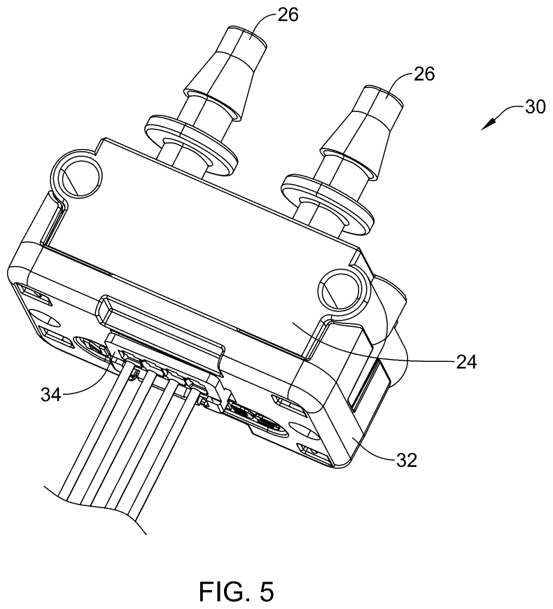

FIG. 5 is a perspective view of an illustrative flow sensor assembly 30. The illustrative flow sensor assembly 30 includes the flow sensor 24, a backing plate 32, and a wiring harness 34 that extends through the backing plate 32 to mechanically and electrically couple with the flow sensor 24. In some cases, the backing plate 32 may be integrally formed with the flow sensor 24. It should be noted that in FIG. 4, the flow sensors 24 are shown within the backing plate 32 and the wiring harness 34.

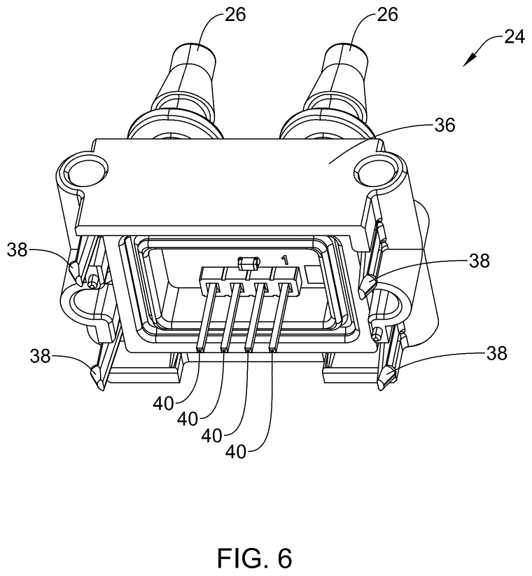

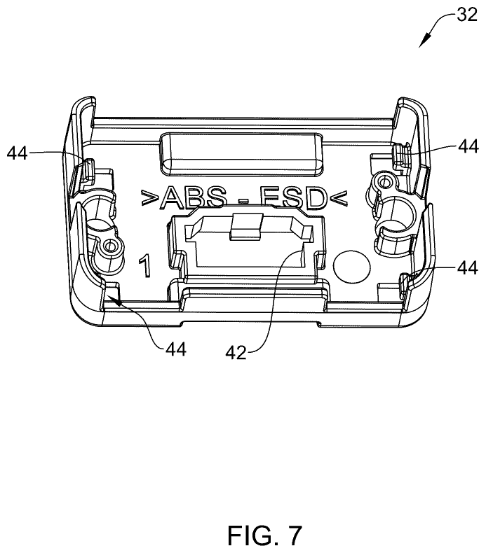

FIG. 6 is a perspective view of the flow sensor 24. The flow sensor 24 has a sensor housing 36 that includes several mounting tabs 38 that allow the flow sensor 24 to be engaged with the backing plate 32. While a total of four mounting tabs 38 are shown, this is merely illustrative. The flow sensor 24 includes several terminal pins 40 that allow the flow sensor 24 to be electrically coupled with the wiring harness 34. The wiring harness 34 may be electrically coupled to a PC board of the building controller. In some cases, the wiring harness 34 may be mechanically coupled to the backing plate 32. In some cases, the wiring harness 34 may connect directly to the flow sensor 24 without being coupled to the backing plate 32. As shown in FIG. 7, the illustrative backing plate 32 includes an aperture 42 that is adapted to releasably engage the wiring harness 34. The backing plate 32 also includes several mounting features 44 that are each adapted to releasably engage one of the mounting tabs 38 extending from the sensor housing 36. The number of mounting features 44 may vary, depending on the location and number of mounting tabs 38 extending from the sensor housing 36.

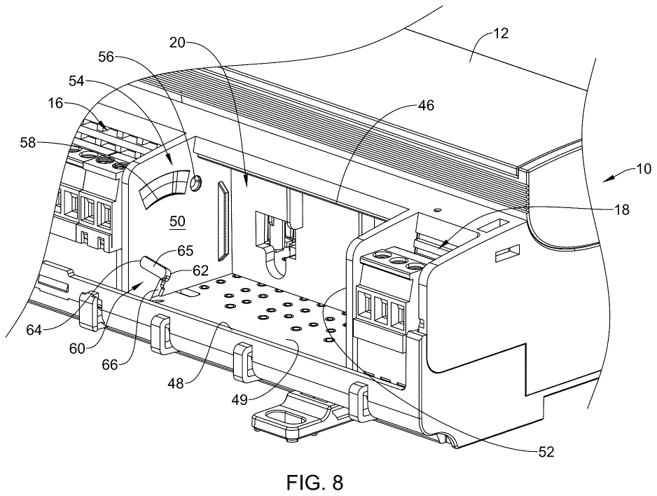

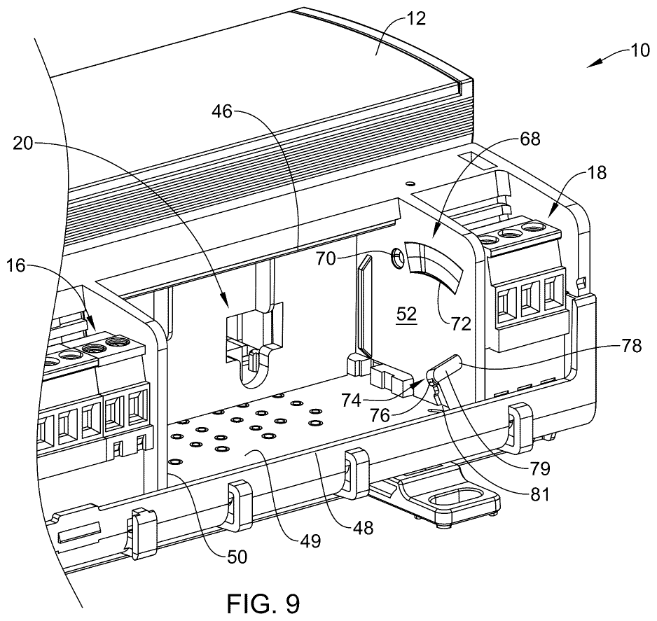

FIGS. 8 and 9 are perspective views of the door opening 20, showing a first side (FIG. 8) and a second side (FIG. 9) of the door opening 20. The door opening 20 includes a top 46, a bottom 48, a first side 50 (FIG. 8) and a second side 52 (FIG. 9). The building controller 10 includes one or more PCB(s), one of which is visible in FIGS. 8 and 9 as a PCB 49. As seen in FIG. 8, the first side 50 includes a rotation guide member 54 that includes a rotation guide member detent 56 and a rotation guide path 58. In some cases, the rotation guide member detent 56 helps to hold the flow sensor door 22 in the closed position until the rotation guide member detent 56 is overcome by a user pulling on the handle 28 of the flow sensor door 22 when opening the flow sensor door 22. The first side 50 also includes a translation guide member 60 that includes a first stop 62 and a second stop 64. In some cases, an elongated translation path 65 extends between the first stop 62 and the second stop 64. In some cases, the translation guide member 60 includes an assembly path 66 that facilitates initially attaching the flow sensor door 22 to the door opening 20, such as in the factory.

As seen in FIG. 9, the second side 52 includes a rotation guide member 68 that includes a rotation guide member detent 70 and a rotation guide path 72. In some cases, the rotation guide member detent 70 helps to hold the flow sensor door 22 in the closed position until the rotation guide member detent 70 is overcome by a user pulling on the handle 28 of the flow sensor door 22 when opening the flow sensor door 22. The second side 52 also includes a translation guide member 74 that includes a first stop 76 and a second stop 78. In some cases, an elongated translation path 79 extends between the first stop 76 and the second stop 78. In some cases, the translation guide member 74 includes an assembly path 81 that facilitates initially attaching the flow sensor door 22 to the door opening 20, such as in the factory.

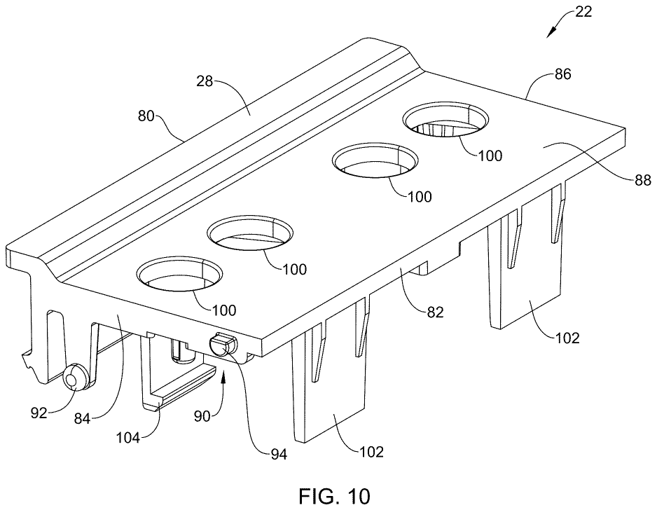

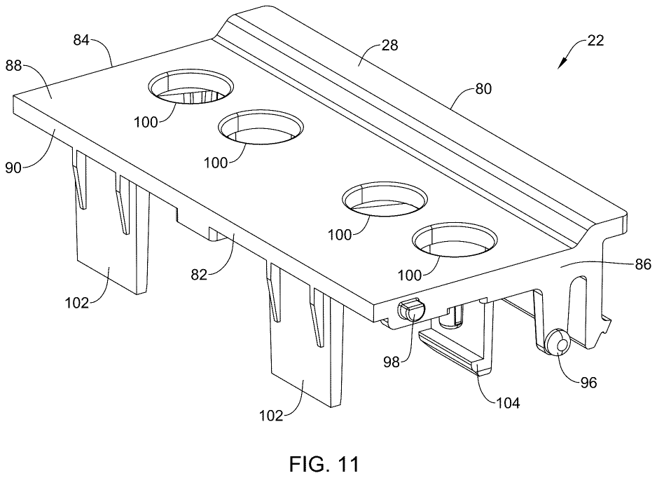

FIGS. 10 and 11 are perspective views of the flow sensor door 22, showing a first side (FIG. 10) and a second side (FIG. 11). The flow sensor door 22 includes a top 80, a bottom 82, a first side 84 and a second side 86. The flow sensor door 22 may be considered as including a front 88 and a back 90. As seen in FIG. 10, the flow sensor door 22 includes a top nub 92 and a bottom nub 94. The top nub 92 is positioned closer to the top 80 of the flow sensor door 22 than the bottom nub 94 and the bottom nub 94 is positioned closer to the bottom 82 of the flow sensor door 22 than the top nub 92. When the bottom nub 94 is at the first stop 62 of the elongated translation path 65, the top nub 92 is configured to engage the rotation guide member 54 of the building controller housing 12 to guide the top nub 92 of the flow sensor door 22 about a rotation axis that may be considered as extending through the first stop 62 until the top nub 92 reaches a release position, and the bottom nub 94 is configured to engage the translation guide members 60 of the building controller housing 12 that guide at least part of the flow sensor door along the elongated translation path after the top nub 92 is rotated to or past the release position. In some cases, the release position corresponds to the top nub 92 reaching a terminus of the rotation guide path 58.

As seen in FIG. 11, the flow sensor door 22 includes a top nub 96 and a bottom nub 98. The top nub 96 is positioned closer to the top 80 of the flow sensor door 22 than the bottom nub 98 and the bottom nub 98 is positioned closer to the bottom 82 of the flow sensor door 22 than the top nub 96. When the bottom nub 98 is at the first stop 76 of the elongated translation path 79, the top nub 96 is configured to engage the rotation guide member 68 of the building controller housing 12 to guide the top nub 96 of the flow sensor door 22 about a rotation axis that may be considered as extending through the first stops 62, 76 until the top nub 96 reaches a release position, and the bottom nub 98 is configured to engage the translation guide member 74 of the building controller housing 12 that guide at least part of the flow sensor door along the elongated translation path after the top nub 96 is rotated to or past the release position. In some cases, the release position corresponds to the top nub 96 reaching a terminus of the rotation guide path 72.

As seen in FIGS. 10 and 11, the translation guide members 60 and 74 define elongated translation paths 65 and 79 that guide the translation of the at least part of the flow sensor door 22 away from the rotation axis. In some cases, the elongated translation paths 65 and 79 include two opposing ends (the first stops 62 and 76 and the second stops 64 and 78). The first stops 62 and 76 position the flow sensor door 22 to rotate about the rotation axis, and the second stops 64 and 78 prevent the flow sensor door 22 from being pulled fully free from the building controller housing 12. In some cases, the elongated translation paths 65 and 79 are configured to translate the bottom nub 94 and 98 of the flow sensor door 22 in a direction that is both away and upward relative to the bottom of the door opening.

In some cases, the flow sensor door 22 includes apertures 100 that allow the tubing ports 26 of each of the flow sensors 24 to extend through the flow sensor door 22 so that pneumatic tubing (not shown) may be secured to each of the tubing ports 26. In some cases, the flow sensors 24 may be secured to the back 90 of the flow sensor door 22. As shown, the back 90 of the flow sensor door 22 includes extensions 102 and 104 that are configured to allow a flow sensor 24 to be snap fit between the extensions 102 and 104. The extensions 102 and 104 hold each flow sensor 24 in place, but allow each flow sensor 24 to be removed when desired so that a replacement flow sensor 24 may be installed.

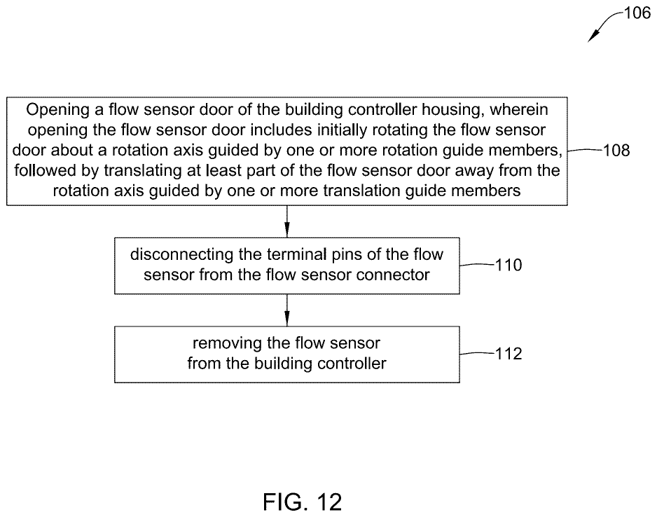

FIG. 12 is a flow diagram showing an illustrative method 106 for removing a flow sensor of a building controller, wherein the building controller includes a building controller housing, a printed circuit board housed by the building controller housing, one or more wiring terminal blocks operatively coupled to the printed circuit board and accessible from outside of the building controller housing, and a flow sensor with one or more tubing ports that are accessible from outside of the building controller housing. The flow sensor including terminal pins that electrically connected to the printed circuit board via a flow sensor connector. In some cases, the flow sensor may include one or more of an absolute pressure sensor, a differential pressure sensor and a microbridge mass airflow sensor. The method 106 includes opening a flow sensor door of the building controller housing, wherein opening the flow sensor door includes initially rotating the flow sensor door about a rotation axis guided by one or more rotation guide members, followed by translating at least part of the flow sensor door away from the rotation axis guided by one or more translation guide members, as indicated at block 108.

In some cases, translating the at least part of the flow sensor door away from the rotation axis may include translating the at least part of the flow sensor door along an elongated translation path that is defined by the one or more translation guide members. In some cases, the elongated translation path may be a linear translation path. In some cases, the elongated translation path may be a non-linear translation path (not explicitly shown). In some cases, the elongated translation path may include two opposing ends, wherein a first one of the two opposing ends includes a first stop that positions the flow sensor door to rotate about the rotation axis, and wherein a second one of the two opposing ends includes a second stop that prevents the flow sensor door from being fully free from the building controller housing. The terminal pins of the flow sensor are disconnected from the flow sensor connector, as indicated at block 110. The flow sensor is removed from the building controller, as indicated at block 112.

In some cases, the flow sensor door may include a top, a bottom, and two opposing sides, wherein each of the two opposing sides have a top nub and a bottom nub, wherein the top nub is positioned closer to the top of the flow sensor door than the bottom nub and the bottom nub is positioned closer to the bottom of the flow sensor door than the top nub, wherein when the bottom nub is at the first stop of the elongated translation path, the top nub is configured to engage one or more of rotation guide members of the building controller housing to guide the top nub of the flow sensor door about the rotation axis until the top nub reaches a release position, and the bottom nub is configured to engage one or more translation guide members of the building controller housing that guide at least part of the flow sensor door along the elongated translation path after the top nub is rotated to or past the release position.

In some cases, the building controller housing may include a door opening to accommodate that flow sensor door, wherein the door opening includes a top, bottom and two lateral sides, wherein the elongated translation path is configured to translate the bottom nub of the flow sensor door in a direction that is both away and upward relative to the bottom of the opening. In some cases, the flow sensor door has a closed position and an open position, and wherein the one or more rotation guide members include a detent to hold the flow sensor door in the closed position until the detent is overcome by a pulling on a handle of the flow sensor door by a user when opening the flow sensor door.

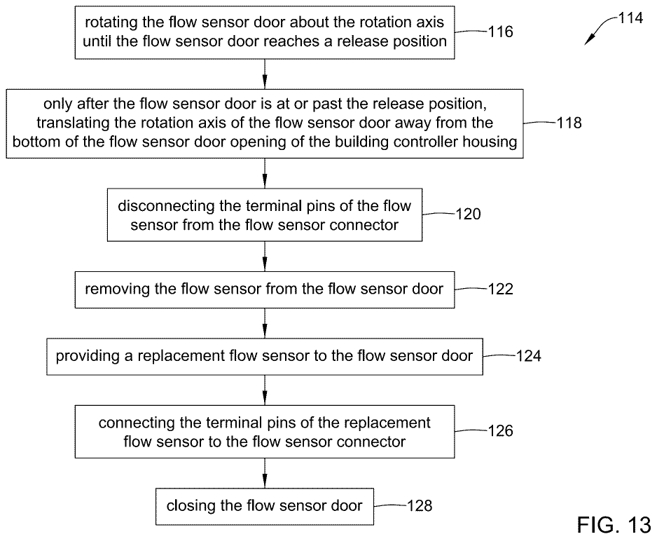

FIG. 13 is a flow diagram showing an illustrative method 114 for removing a flow sensor of a building controller, wherein the building controller includes a building controller housing that defines a flow sensor door opening to accommodate a flow sensor door, wherein the flow sensor door opening includes a top, bottom and two lateral sides. The building controller further including a printed circuit board housed by the building controller housing, one or more wiring terminal blocks operatively coupled to the printed circuit board and accessible from outside of the building controller housing, and a flow sensor with one or more tubing ports that are accessible from outside of the building controller housing. The flow sensor includes terminal pins that electrically connected to the printed circuit board via a flow sensor connector. In some cases, the flow sensor is operatively attached to the flow sensor door. The illustrative method 114 includes rotating the flow sensor door about the rotation axis until the flow sensor door reaches a release position, as indicated at block 116. Only after the flow sensor door is at or past the release position, the rotation axis of the flow sensor door is translated away from the bottom of the flow sensor door opening of the building controller housing, as indicated at block 118. The terminal pins of the flow sensor are disconnected from the flow sensor connector, as indicated at block 120. The flow sensor is removed from the flow sensor door, as indicated at block 122. In some cases, a replacement flow sensor is provided to the flow sensor door, as indicated at block 124. The terminal pins of the replacement flow sensor may be connected to the flow sensor connector, as indicated at block 126. The flow sensor door is closed, as indicated at block 128.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for removing a flow sensor of a building controller, wherein the building controller includes a building controller housing, a printed circuit board housed by the building controller housing, one or more wiring terminal blocks operatively coupled to the printed circuit board and accessible from outside of the building controller housing, and a flow sensor with one or more tubing ports that are accessible from outside of the building controller housing, the flow sensor including terminal pins that electrically connected to the printed circuit board via a flow sensor connector, the method comprising:
opening a flow sensor door of the building controller housing, wherein opening the flow sensor door includes initially rotating the flow sensor door about a rotation axis guided by one or more rotation guide members, followed by translating at least part of the flow sensor door away from the rotation axis guided by one or more translation guide members;
disconnecting the terminal pins of the flow sensor from the flow sensor connector; and
removing the flow sensor from the building controller.

2. The method of claim 1, wherein translating the at least part of the flow sensor door away from the rotation axis includes translating the at least part of the flow sensor door along an elongated translation path that is defined by the one or more translation guide members.

3. The method of claim 2, wherein the elongated translation path is a linear translation path.

4. The method of claim 2, wherein the elongated translation path is a non-linear translation path.

5. The method of claim 2, wherein the elongated translation path includes two opposing ends, wherein a first one of the two opposing ends includes a first stop that positions the flow sensor door to rotate about the rotation axis, and wherein a second one of the two opposing ends includes a second stop that prevents the flow sensor door from being fully free from the building controller housing.

6. The method of claim 5, wherein the flow sensor door includes a top, a bottom, and two opposing sides, wherein each of the two opposing sides have a top nub and a bottom nub, wherein the top nub is positioned closer to the top of the flow sensor door than the bottom nub and the bottom nub is positioned closer to the bottom of the flow sensor door than the top nub, wherein when the bottom nub is at the first stop of the elongated translation path, the top nub is configured to engage one or more of rotation guide members of the building controller housing to guide the top nub of the flow sensor door about the rotation axis until the top nub reaches a release position, and the bottom nub is configured to engage one or more translation guide members of the building controller housing that guide at least part of the flow sensor door along the elongated translation path after the top nub is rotated to or past the release position.

7. The method of claim 6, wherein the building controller housing includes a door opening to accommodate that flow sensor door, wherein the door opening includes a top, bottom and two lateral sides, wherein the elongated translation path is configured to translate the bottom nub of the flow sensor door in a direction that is both away and upward relative to the bottom of the opening.

8. The method of claim 7, wherein the flow sensor door has a closed position and an open position, and wherein the one or more rotation guide members include a detent to hold the flow sensor door in the closed position until the detent is overcome by a pulling on a handle of the flow sensor door by a user when opening the flow sensor door.

9. The method of claim 1, wherein the flow sensor comprises one or more of an absolute pressure sensor, a differential pressure sensor and a microbridge mass airflow sensor.

10. A building controller comprising:
a building controller housing including a flow sensor door;
a printed circuit board housed by the building controller housing;
one or more wiring terminal blocks operatively coupled to the printed circuit board and accessible from outside of the building controller housing;
a flow sensor with one or more tubing ports that are accessible from outside of the building controller housing, the flow sensor including terminal pins that electrically connected to the printed circuit board via a flow sensor connector, the flow sensor operatively attached to the flow sensor door; and
wherein the building controller housing is configured to allow the flow sensor door to move between a closed position and an open position, wherein when moving from the closed position to the open position, the flow sensor door initially rotates about a rotation axis guided by one or more rotation guide members, followed by translating at least part of the flow sensor door away from the rotation axis guided by one or more translation guide members.

11. The building controller of claim 10, wherein the one or more translation guide members define an elongated translation path that guide the translation of the at least part of the flow sensor door away from the rotation axis.

12. The building controller of claim 11, wherein the elongated translation path includes two opposing ends, wherein a first one of the two opposing ends includes a first stop that positions the flow sensor door to rotate about the rotation axis, and wherein a second one of the two opposing ends includes a second stop that prevents the flow sensor door from being fully free from the building controller housing.

13. The building controller of claim 12, wherein the flow sensor door includes a top, a bottom, and two opposing sides, wherein each of the two opposing sides have a top nub and a bottom nub, wherein the top nub is positioned closer to the top of the flow sensor door than the bottom nub and the bottom nub is position closer to the bottom of the flow sensor door than the top nub, wherein when the bottom nub is at the first stop of the elongated translation path, the top nub is configured to engage one or more of rotation guide members of the building controller housing to guide the top nub of the flow sensor door about the rotation axis until the top nub reaches a release position, and the bottom nub is configured to engage one or more translation guide members of the building controller housing that guide at least part of the flow sensor door along the elongated translation path after the top nub is rotated to or past the release position.

14. The building controller of claim 13, wherein the building controller housing defines a door opening to accommodate that flow sensor door, wherein the door opening includes a top, bottom and two lateral sides, wherein the elongated translation path is configured to translate the bottom nub of the flow sensor door in a direction that is both away and upward relative to the bottom of the door opening.

15. The building controller of claim 14, wherein the one or more rotation guide members include a detent to hold the flow sensor door in the closed position until the detent is overcome by a pulling on a handle of the flow sensor door by a user when opening the flow sensor door.

16. The building controller of claim 10, wherein the flow sensor comprises one or more of an absolute pressure sensor, a differential pressure sensor and a microbridge mass airflow sensor.

17. The building controller of claim 1, wherein the one or more tubing ports of the flow sensor extend through one or more apertures in the flow sensor door.

18. A method for removing a flow sensor of a building controller, wherein the building controller includes a building controller housing that defines a flow sensor door opening to accommodate a flow sensor door, wherein the flow sensor door opening includes a top, bottom and two lateral sides, the building controller further including a printed circuit board housed by the building controller housing, one or more wiring terminal blocks operatively coupled to the printed circuit board and accessible from outside of the building controller housing, and a flow sensor with one or more tubing ports that are accessible from outside of the building controller housing, the flow sensor including terminal pins that electrically connected to the printed circuit board via a flow sensor connector, the flow sensor operatively attached to the flow sensor door, the method comprising:
opening the flow sensor door of the building controller housing, including rotating the flow sensor door about a rotation axis adjacent the bottom of the flow sensor door and translating the rotation axis of the flow sensor door away from the bottom of the flow sensor door opening of the building controller housing;
disconnecting the terminal pins of the flow sensor from the flow sensor connector; and
removing the flow sensor from the flow sensor door.

19. The method of claim 18, wherein opening the flow sensor door comprises rotating the flow sensor door about the rotation axis until the flow sensor door reaches a release position, and only after the flow sensor door is at or past the release position, translating the rotation axis of the flow sensor door away from the bottom of the flow sensor door opening of the building controller housing.

20. The method of claim 18 comprising:
providing a replacement flow sensor to the flow sensor door;
connecting the terminal pins of the replacement flow sensor to the flow sensor connector; and
closing the flow sensor door.
